(19) United States
(12) Patent Application Publication
(10) Pub. No.: US 2020/0028961 A1
(43) Pub. Date: Jan. 23, 2020

(54) SWITCHING PRESENTATIONS OF REPRESENTATIONS OF OBJECTS AT A USER INTERFACE

(71) Applicant: Alibaba Group Holding Limited, George Town (KY)

(72) Inventors: Haixin Wang, Hangzhou (CN); Xingan Jin, Hangzhou (CN); Zhijun Yuan, Hangzhou (CN); Wenhan Bian, Hangzhou (CN)

(21) Appl. No.: 16/526,817

(22) Filed: Jul. 30, 2019

Related U.S. Application Data
(63) Continuation-in-part of application No. PCT/CN2018/074225, filed on Jan. 26, 2018.

(30) Foreign Application Priority Data
Feb. 7, 2017 (CN) 201710068009.X

(51) Int. Cl. H04M 1/725; G06F 16/16; G06F 3/0481

(52) U.S. Cl. CPC H04M 1/72586; G06F 3/04817; G06F 3/04812; G06F 16/168

(57) ABSTRACT

Switching presentations of representations of objects at a user interface is disclosed, including: receiving an indication to switch from a first-mode presentation of a plurality of first-mode representations corresponding to respective ones of a plurality of objects, wherein the plurality of first-mode representations comprises static identifiers associated with the plurality of objects; obtaining respective current state data corresponding to the plurality of objects from the plurality of objects; dynamically generating a plurality of second-mode representations corresponding to respective ones of the plurality of objects based at least in part on the respective current state data associated with the plurality of objects; and replacing, at a user interface, the first-mode presentation of the plurality of first-mode representations with a second-mode presentation of at least a portion of the plurality of second-mode representations corresponding to respective ones of the plurality of objects.

### CROSS REFERENCE TO OTHER APPLICATIONS

This application is a continuation-in-part of and claims priority to International (PCT) Application No. PCT/CN2018/074225, entitled METHOD AND DEVICE FOR VIEW TRANSITION filed on Jan. 26, 2018 which is incorporated herein by reference in its entirety for all purposes, which claims priority to China Patent Application No. 201710068009.X, entitled A VIEW SWITCHING METHOD AND MEANS, filed on Feb. 7, 2017 which is incorporated by reference in its entirety for all purposes.

### FIELD OF THE INVENTION

The present application relates to a field of user interface technology. In particular, the present application relates to switching between presentations of different representations of objects at the user interface.

### BACKGROUND OF THE INVENTION

As computer technology and Internet applications develop, an ever increasing number of software programs (e.g., applications) are used by people to meet their work and everyday living needs.

There are ever more application programs capable of running on terminals. To make it easier for a user to select an application program, application icons may, at the present time, be displayed on the operating system desktop of a terminal to enable the user to intuitively select from application icons of the application program that needs to be run.

However, the above display mode provided by the prior art is fixed and does not provide the user additional information regarding the application no matter how it was recently used, for example. The question of how to enrich display modes to facilitate user selection of applications is a problem that the industry needs to solve.

### SUMMARY OF THE INVENTION

The present application discloses techniques comprising:

receiving an indication to switch from a first-mode presentation of a plurality of first-mode representations corresponding to respective ones of a plurality of objects, wherein the plurality of first-mode representations comprises static identifiers associated with the plurality of objects; obtaining respective current state data corresponding to the plurality of objects from the plurality of objects; dynamically generating a plurality of second-mode representations corresponding to respective ones of the plurality of objects based at least in part on the respective current state data associated with the plurality of objects; and replacing, at a user interface, the first-mode presentation of the plurality of first-mode representations with a second-mode presentation of at least a portion of the plurality of second-mode representations corresponding to respective ones of the plurality of objects.

### BRIEF DESCRIPTION OF THE DRAWINGS

Various embodiments of the invention are disclosed in the following detailed description and the accompanying drawings.

FIG. 1 is a diagram showing a first-mode view of objects at a user interface of a device.

FIG. 2 is a diagram showing a second-mode view of objects at a user interface of a device.

FIG. 3 is a diagram showing an example of a system for switching presentations of representations of objects at a user interface.

FIG. 4 is a diagram showing a second example of a system for switching presentations of representations of objects at a user interface.

FIG. 5 is a flow diagram showing an embodiment of a process for switching object representation views at a device display screen.

FIG. 6 is a flow diagram showing an embodiment of a process for switching from a first-mode view to a second-mode view at a device display screen.

FIG. 7 is a flow diagram showing an embodiment of a process for switching from a second-mode view to a first-mode view at a device display screen.

FIG. 8 is a diagram showing an embodiment of a system architecture of a mobile phone.

FIG. 9 shows an example first-mode view at a display screen of a mobile phone.

FIG. 10 shows an example second-mode view at a display screen of a mobile phone.

FIG. 11 is a diagram of an embodiment of a communication device that is configured to switch presentations of representations of objects at a user interface.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Although the concepts of the present application may easily undergo various modifications and substitutions, its specific embodiments have already been shown through the examples in the drawings and in the detailed descriptions in this document. However, please note that there is no intention of limiting the concepts of the present application to the disclosed specific forms. On the contrary, the intention is to cover all modifications, equivalents, and substitutions consistent with the present application and the attached claims.

In citing “an embodiment,” “embodiments,” “an illustrative embodiment,” etc., the Detailed Description is indicating that the described embodiment may include specific features, structures, or characteristics. However, each embodiment may or may not include particular features, structures, or characteristics. In addition, such phrases do not necessarily refer to the same embodiments. Furthermore, it is believed that, when the features, structures, or characteristics are described in light of embodiments, such features, structures, or characteristics are affected through their combination with other embodiments (whether they are described clearly or not) within the scope of knowledge of persons skilled in the art. In addition, please understand that the items included in a list taking the form of “at least one of A, B and C” may be expressed as: (A), (B), (C), (A and B), (A and C), (B and C), or (A, B, and C). Similarly, items listed in the form of “at least one of A, B or C” may be expressed as: (A), (B), (C), (A and B), (A and C), (B and C), or (A, B, and C).

In some cases, the disclosed embodiments may be implemented as hardware, firmware, software, or any combination thereof. The disclosed embodiments may also be implemented as instructions that are carried or stored in one or more temporary or non-temporary machine-readable (e.g., computer-readable) storage media that can be read and executed by one or more processors. Machine-readable storage media may be embodied as any storage devices, mechanisms, or other devices with physical structures used to store or transmit information in machine-readable form (such as volatile or non-volatile memory, media disks, or other media).

In the drawings, some structures or method features may be shown in specific layouts and/or sequences. However, please understand that these specific layouts and/or sequences may be unnecessary. On the contrary, in some embodiments, these features may be laid out in ways and/or sequences that differ from what is shown in the illustrative drawings. In addition, the fact that a particular drawing includes structural or method features does not imply that such features are necessary in all embodiments. Moreover, in some embodiments, they may not be included, or they may be combined with other features.

Embodiments of switching presentations of representations of objects at a user interface are described herein. An indication to switch from a first presentation, at a user interface of a device, of a plurality of first representations corresponding to respective ones of a plurality of objects is received. For example, the objects are software programs (e.g., applications) that are executing at the device. The first representations include media comprising static identifiers associated with the objects. For example, the first representations comprise icons (e.g., images) corresponding to the applications. Respective current state data corresponding to the objects is obtained from the objects. In some embodiments, the objects themselves are queried for current state data. Current state data corresponding to an object that is a messaging application includes, for example, recent messages that have been received by the messaging application. A plurality of second representations corresponding to respective ones of the plurality of objects is dynamically generated based at least in part on the respective current state data associated with the plurality of objects. For example, a second representation comprises an interactive display pane that includes at least some of the object's current state data. The first presentation of the first representations is replaced with a second presentation of at least a portion of the plurality of second representations corresponding to respective ones of the plurality of objects.

Various embodiments described herein may be applied to a computing device. The computing device may be any appropriate computing or mobile device and may include, for example: a smart phone, a tablet, a notebook computer, a personal digital assistant (PDA), a smart wearable device, or a similar device. The operating system of the device may operate on the basis of views, which may be called windows. In various embodiments, a main screen region called a desktop is presented at the display screen after the device is turned on and the operating system is activated.

In various embodiments, representations of objects associated with the device are presented in at least one of what is sometimes referred to as a “first-mode view” and a “second-mode view” at the user interface. In some embodiments, the objects comprise applications that are installed and/or executing at the device. In various embodiments, the first-mode view displays what is sometimes referred to as “first-mode representations” of the objects. Each first-mode representation corresponds to one object. The second-mode view displays what is sometimes referred to as “second-mode representations” of the objects. Each second-mode representation corresponds to one object. The first-mode view and the second-mode view may be views of the objects that are provided at the operating system main page (e.g., a desktop) and serve to provide user access to the objects (e.g., applications) that are installed and/or executing at the device. As will be described in detail below, presentations of the first-mode view and second-mode view are switched back and forth at a display screen of a device.

In various embodiments, both the first-mode representations and the second-mode representations may be used by a user to activate corresponding objects (e.g., applications). First-mode representations and second-mode representations differ in terms of their presentation. In some embodiments, the first-mode representations are object icons. In a specific example, first-mode representations may be application icons. Thus, the first-mode view is a view that comprises multiple object icons. In various embodiments, an object icon is static in the sense that its appearance is predetermined for each object. For example, an object icon comprises a thumbnail image that includes the object's name but it does not present a preview of the current state of the object. When the icon of an application is selected by a user, the device may activate/open the application (if the application has not yet been activated/open), or it may switch to the application (if the application has previously been activated/opened). In some embodiments, the second-mode representations are interactive display panes. For example, a second-mode representation may be referred to as a “card.” In various embodiments, a card (second-mode representation) corresponding to an object may present at least a portion of the current state data of the corresponding object. The objects corresponding to the “cards” in the second-mode view may be objects that correspond to all or some of the object icons in the first-mode view. The current state data corresponding to the object which is presented by a corresponding card that may include information that is more detailed than what is presented by the corresponding object icon in the first-mode view. In various embodiments, the information presented by a “card” corresponding to an object may include, but is not limited to, one or more of the following: the object icon, the object name, the object's current state data, and a control used to control the object. Thus, the second-mode view is a view that includes more detailed information about some or all of the objects in the first-mode view.

In some embodiments, when a device is turned on, the first-mode view may be the default view that is displayed on the device's desktop, or the second-mode view may be the default view displayed on the device's desktop. In various embodiments, “objects” referred to here may include, but are not limited to, one or more of the following: applications, components, file folders, and files. Applications may include system applications and third party applications. Components may be programs that complete certain functions. Generally, a component has a narrower range of functions than an application. One application may include many components. A file folder may include entries to one or more applications. For example, a file folder may include one or more application icons. Thus, multiple applications may be effectively organized according to functions, use habits, or other such factors for the convenience of the user.

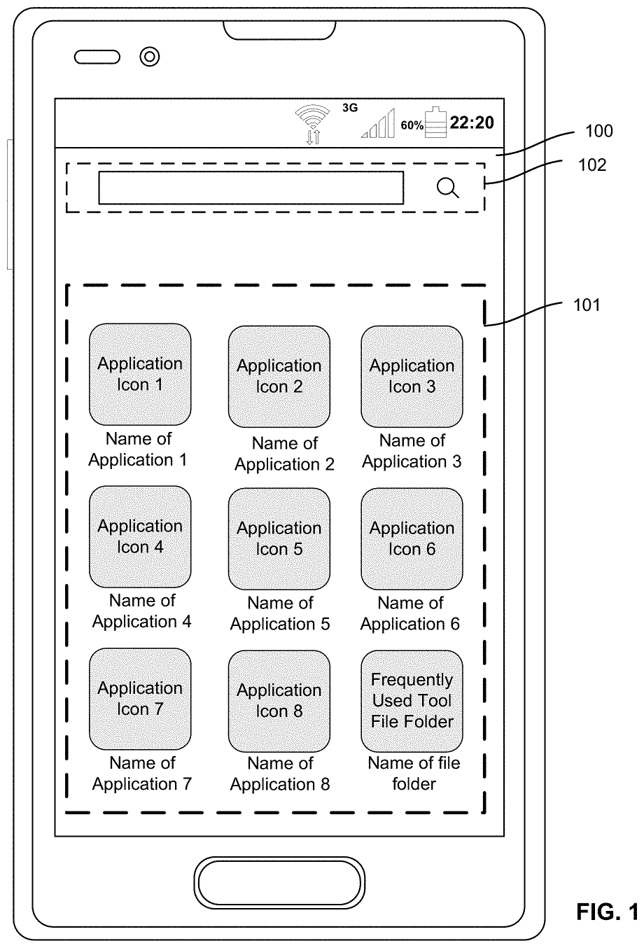

FIG. 1 is a diagram showing a first-mode view of objects at a user interface of a device. First-mode view 100 includes first display region 101. First display region 101 displays first-mode representations. In the example of FIG. 1, the first-mode representations are object icons, with each icon corresponding to one object. First display region 101 includes nine icons, eight of them application icons (e.g., “Application Icon 1,” “Application Icon 2,” . . . , “Application Icon 8”) and the last of them a folder icon (e.g., “Frequently Used Tool File Folder”). Each application icon corresponds to one application that is installed and/or executing at the device. When one of the object icons is selected by a user (e.g., via a finger tap), the corresponding application is activated/opened.

The object icon that is labeled “Frequently Used Tool File Folder” is a file folder icon. In this example, this file folder includes one or more application icons. When this file folder icon is selected by a user, a window corresponding to the file folder is presented. The window corresponding to the file folder includes the application icons that are included in the file folder.

In the example of FIG. 1, first-mode view 100 further includes information search region 102, which includes a search keyword input box and a search button. The user may input search keywords in the search keyword input box and select the search button to conduct a search for objects at the device according to the search keywords that were input by the user.

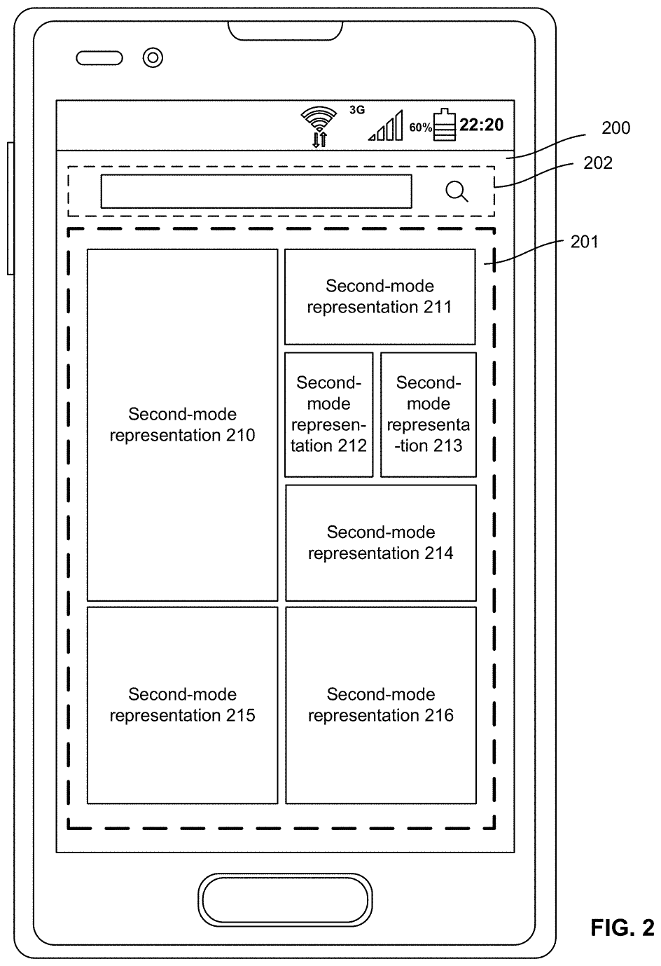

FIG. 2 is a diagram showing a second-mode view of objects at a user interface of a device. Second-mode view 200 includes second display region 201 and information search region 202. Second display region 201 displays second-mode representations. In the example of FIG. 2, second display region 201 is partitioned into one or more subregions, and each subregion displays one second-mode representation (e.g., second-mode representation 210 through the second-mode representation 216) that is matched to the shape of that subregion. Partitioning second display region 201 into multiple subregions causes each subregion of second display region 201 to appear in the form of “interactive display panes.” Thus, relevant information about objects (e.g., applications, components, files, or file folders) is presented as “interactive display panes” (second-mode representations) to inform the user of at least some current state data corresponding to each of the objects.

In the example of FIG. 2, second-mode representations 210 through 216 may correspond to respective objects such as applications, for example. Second-mode representations 210 through 216 appear similar in form to cards. In other examples, the sizes of all the subregions in a second display region in a second-mode view may be the same, with the result that the sizes of all the second-mode representations in the second-mode view being the same. In some embodiments, the second display region in the second-mode view may have at least two subregions of different sizes such that at least two of all the second-mode representations in the second-mode view will differ in size.

In some embodiments, the shapes of all the subregions in the second display region in the second-mode view may be the same and as a result, the shapes of all the second-mode representations in the second-mode view are the same. In some embodiments, the second display region in the second-mode view may have at least two subregions of different shapes and as a result, at least two of all the second-mode representations in the second-mode view are different in shape.

In some embodiments, the shapes of the second-mode representations in the second display region in the second-mode view are polygonal, e.g., triangular, quadrilateral, pentagonal, etc. In some embodiments, the shapes of the second-mode representations are rectangular (including square). In the specific example of FIG. 2, the shapes of the second-mode representations in second display region 201 in second-mode view 200 are rectangular, and the sizes of the different second-mode representations differ.

In some embodiments, the sizes of the second-mode representations may be set in advance. For example, the size of each second-mode representation in the second display region in the second-mode view is determined according to the size of the screen display region of the device. In some embodiments, the sizes of the second-mode representations may be (e.g., dynamically) determined according to one or any combination of the following factors associated with the objects corresponding to the second-mode representations:

Type of object. Settings may be made in advance to designate which types of objects that correspond to second-mode representations should occupy larger subregions of the second display region of the second-mode view of objects. In particular, it is possible to preset the size ratios between second-mode representations for objects of various types. In one example, the sizes of second-mode representations corresponding to social-networking applications and media-playing applications (e.g., music player applications) may be preset to be relatively larger than other types of applications, and the sizes of second-mode representations corresponding to other types of application programs may be preset to be relatively smaller.

Historical use frequency of object. The relative size of the second-mode representation corresponding to an object may be preset according to the historical use frequency of the object. In one example, the sizes of second-mode representations corresponding to objects with higher historical use frequencies are preset to be larger than the sizes of second-mode representations corresponding to objects with lower historical use frequencies. It is thus possible to display second-mode representations according to specific user habits so that the user can more conveniently interact with the representations that he or she has historically more frequently accessed.

Update time of object. The size of the second-mode representation corresponding to an object may be set according to the most recent update time of the object. In one example, the sizes of second-mode representations corresponding to objects whose update times are closer to the current time (i.e., whose update times are more recent) are larger than the sizes of second-mode representations corresponding to objects whose update times are farther from the current time (i.e., whose update times are less recent).

In some embodiments, the arrangement of the second-mode representations may be predetermined. The arrangement of the second-mode representations describes the placement (e.g., location of display within the area of the display screen) of the second-mode representation corresponding to each object at the display screen. The arrangement may, for example, describe the relative locations of the second-mode representations such as which should be presented at a more prioritized area on the display area relative to other second-mode representations. In some embodiments, the arrangement of the second-mode representations corresponding to the objects may be determined according to the arrangement of the first-mode representations corresponding to the same objects in the first-mode view. For example, the arrangement of second-mode representations corresponding to objects may be in the same or a different arrangement from the arrangement of their counterpart first-mode representations. In some other embodiments, the arrangement of the second-mode representations may be dynamically determined (e.g., each time that the second-mode view is requested to be presented at the user interface) according to one or any combination of the following attributes of the objects corresponding to the second-mode representations:

Type of object. Settings may be made in advance to designate which types of objects that correspond to second-mode representations should be placed closer to the front (e.g., more prioritized and/or more conspicuous portion) of the arrangement and which types of objects that correspond to second-mode representations should be placed closer to the back (e.g., less prioritized and/or less conspicuous portion) of the arrangement. For example, if the arrangement of second-mode representations described their order from the top to the bottom of the display screen of the device, then the “front” of the arrangement may refer to the top of the display screen while the “end” of the arrangement may refer to the bottom of the display screen. In one example, the second-mode representations corresponding to social-networking applications and media-playing applications (such as music players) may be placed closer to the front of the arrangement if the user of the device had historically accessed those applications more frequently than other applications, and the second-mode representations corresponding to other types of applications may be placed closer to the end of the arrangement.

Historical use frequency of object. The arrangement of second-mode representations corresponding to objects may be set according to the historical use frequencies of the objects. In one example, second-mode representations corresponding to objects with higher historical use frequencies are placed closer to the front of the arrangement than second-mode representations corresponding to objects with lower historical use frequencies. It is thus possible to display second-mode representations according to specific user habits so that users can more quickly select the objects that he or she has historically more frequently accessed.

Update time of object. The arrangement of second-mode representations corresponding to objects may be set according to the update times of the objects. In some example, second-mode representations corresponding to objects whose update time is closer (i.e., whose update times are more recent) to the current time are placed closer to the front than second-mode representations corresponding to objects whose update time is farther from the current time (i.e., whose update times are less recent).

In some embodiments, the second-mode representations in the second-mode view are configured to provide one or a combination of the functions below:

To display descriptive information about the object. A user of the device may gain an understanding of the objects corresponding to the second-mode representations, e.g., an understanding of the functions provided by the corresponding applications, based on the descriptive information about the objects from their respective second-mode representations. In one example, the word “music” is displayed in text form in the second-mode representation corresponding to an application for playing music to show that the application is operable to play music. The descriptive information may also be information of other media types besides text, such as images. To again use the example of an application for playing music, its corresponding second-mode representation may include an image that depicts a music symbol. Based on the content of this image, the user can know that the corresponding application is operable to play music.

To display current state data of the corresponding object. The current state data of the object corresponding to the particular second-mode representation may be displayed. The current state data of the object may include recent data that the object has obtained with respect to its function. For example, if the object were an application that periodically exchanged information with a server, the current state data of the object may include data that it has recently received from the server. For example, in the case of a weather information application, information on current weather conditions (e.g., that was obtained from a weather information server) may be displayed in the second-mode representation corresponding to that application. In another example, in the case of an email application, previews of recently received messages (e.g., that were obtained from an email server) at the device may be displayed in the second-mode representation corresponding to that application.

To enable activation of the corresponding object. For example, a user operation directed at a second-mode representation (e.g., a tap on the second-mode representation) may activate/open the corresponding application. To give another example, an operation directed at a second-mode representation (e.g., a tap on the second-mode representation) may open the corresponding file folder and cause the first-mode or second-mode representations of objects that are included in the file folder to be presented.

To enable switching to the corresponding object. For example, when a particular application has already been activated/opened but since has been executing in the background (e.g., the application was not currently presented at the display screen), an operation performed on the second-mode representation corresponding to the application may cause the system to switch to the application to bring it to the foreground (e.g., to cause the application to be presented at the display screen).

To select a set operation in the corresponding object. For example, a control may be provided in a second-mode representation which, in response to being selected by a user, activates/triggers a set function in the corresponding application to be performed. Thus, when the user triggers this control, he or she triggers the corresponding function of the application. Play and pause function buttons may, for example, be provided on the second-mode representation corresponding to a media player application. After the user taps the corresponding function button, the control function for playing is triggered through the corresponding function button.

In some embodiments, one or more of the following types of content may be displayed in a second-mode representation corresponding to an object:

One or more pieces of media (e.g., images, videos, audio, and text) that describe the corresponding object. For example, media that describes the corresponding object may comprise images and/or text that identifies the name of the object.

Current state data associated with the corresponding object. For example, current state data comprises one or more of images, videos, audio, and text. For example, the at least portion of the current state data associated with the corresponding object that is presented in the second-mode representation corresponding to that object comprises a preview of the current state data. In a specific example, if the object were a messaging application, then the respective identifier of the sender of a predetermined number of messages that have been recently received at the device and as well as the beginning of each such message may be presented within the second-mode representation for the messaging application.

One or more controls that are configured within the corresponding object. For example, a control that is presented within a second-mode representation of a corresponding object is a control that is usually presented within at least a page of the object after it has been activated. The selection of the control will cause a corresponding operation to be performed within and/or by the corresponding object. For example, if the object were a media player application, then a playback control (e.g., a play button, a fast forward button, a rewind button, and/or a pause button) may be presented within the second-mode representation for the media player application such that the playback of the media content that is currently presented by the media player application is correspondingly affected within the second-mode representation itself or the media player application is activated/opened and the playback of the media content that is currently presented by the media player application is correspondingly affected within the opened media player application.

The above examples are for purposes of illustration and other types of content can be used in other embodiments.

In some embodiments, at least some of the types of the content (such as the three described above) that may be displayed in a second-mode representation corresponding to an object are determined dynamically each time that the second-mode view is requested to be presented at the display screen of a device.

In some embodiments, the second-mode view is one page such that all the second-mode representations (e.g., that are determined to be the arrangement) may be included in the page. If there are numerous second-mode representations contained on the page, the page's length may exceed the size of the terminal desktop (i.e., the display region of the terminal screen such as second display region 201 of FIG. 2). In such a situation, a portion of the second-mode representations may be initially presented at the display screen of the device and the user may interact with the display screen to scroll down the page of second-mode representations to view previously hidden second-mode representations. For example, a user interactive action for triggering the page to scroll may serve to scroll the page and display previously hidden second-mode representations at the appropriate positions on the display screen. In a first example, the user interactive action for scrolling the page may be an operation on the touchscreen (such as an upward swipe operation) of the device. In a second example, the user interactive action may be an operation to control a seek bar. In a third example, the user interactive action may be a voice command.

In some embodiments, the second-mode view includes more than one page such that all the second-mode representations (e.g., that is determined to be the arrangement) are divided among the different pages, where each page includes at least one second-mode representation. All second-mode representations may be displayed across these multiple pages, with different second-mode representations being displayed on different pages. Multiple pages may be used to present the second-mode view when, for example, one page is unable to display all the second-mode representations. A user would perform an interactive action with respect to the display screen to switch among different pages of second-mode representations. A target page may be determined from among the multiple pages according to a user interactive action used to trigger switching between the multiple pages. A first example of a user interactive action for scrolling from page to page may be an operation on the touchscreen (such as a swiping operation to the left or the right). A second example of a user interactive action may be a voice command.

In some embodiments, computer instructions, which are sometimes referred to as “events,” are issued (e.g., by a device's operating system) to the objects of the device to prepare and cause the switch between a first-mode view and a second-mode view of objects at the display screen of the device. The following are example events that can be defined for the purpose of switching between views in different modes:

A first example event is also called a “preparation event.” The preparation event may be issued to the objects whose corresponding first-mode representations are presented in the currently presented first-mode view to instruct the corresponding objects to determine the objects' setting information that is to be used to generate the objects' corresponding second-mode representations and to cache the determined setting information for the second-mode representations. Examples of such “setting information” corresponding to objects are described further below. In some embodiments, one or more preparation events may be issued to objects whose corresponding first-mode representations are presented in the currently presented first-mode view to cause them to determine and cache the latest setting information.

A second example event is also called a “creation event.” The creation event may be issued to the objects whose corresponding first-mode representations are presented in the currently presented first-mode view when the currently presented first-mode view is requested to switch to the second-mode view. The creation event is used to obtain, from the corresponding objects, the determined and cached setting information for the second-mode representations corresponding to the objects (e.g., that had been determined and cached in response to a previously issued preparation event). The objects' setting information is to be used to generate the second-mode representations corresponding to the objects and where the second-mode representations are to be presented at the display screen in the second-mode view. In some embodiments, the setting information corresponding to various objects is obtained by the device's operating system and then the operating system is configured to generate the object's corresponding second-mode representations based on the respective setting information.

A third example event is also called an “update event.” The update event may be issued to the objects whose corresponding first-mode representations are presented in the currently presented first-mode view in response to a requested switch from the first-mode view to the second-mode view. The update event is used to acquire, from the corresponding objects, any updated setting information corresponding to the objects. For example, the update event may instruct the objects to determine and cache any setting information that had been newly added or changed since the objects had executed the latest preparation event.

A fourth example event is also called an “exit event.” The exit event may be issued to the objects whose corresponding first-mode representations are to be presented in the first-mode view in response to a requested switch from the second-mode view to the first-mode view (i.e., when the second-mode view is to be exited from). This event is configured to notify the corresponding objects that the system has exited the second-mode view and is now switching to the first-mode view.

The above example events are for purposes of illustration, and different events can be used in other embodiments.

In some embodiments, the setting information that is determined by an object and is to be used to generate the object's second-mode representation may comprise one or any combination of the example content below:

One or more of the arrangement mode (e.g., whether it is arranged according to two rows and two columns or according to three rows and three columns), position (e.g., which column and which row), size (e.g., number of pixels long and wide in the case of a rectangle), and shape in the second-mode view of the second-mode representations corresponding to the objects. In some embodiments, the arrangement is predetermined. In some embodiments, the operating system executing at a device and/or the objects executing at the device periodically and dynamically determine the arrangement of the second-mode representations of objects at the device based on current factors such as those described above (e.g., the type of the object, the historical user frequency of the object, and the update time of the object). Regardless of how the arrangement is determined, the arrangement identifies, for each object, the display location of the object's second-mode representation within the area of the display screen and the dimensions of the object's second-mode representation. The display location and the dimensions of each object's second-mode representation of the arrangement are sent to the corresponding object.

Descriptive information associated with the object that is to be presented in the object's second-mode representation. The descriptive information may include one or more of images, video, audio, and text.

Current state data associated with the object that is to be presented in the second-mode representation. As mentioned above, current state data associated with the object may include recent data that the object has obtained with respect to the object's function.

A control associated with the object that is to be presented in the second-mode representation. As mentioned above, a control associated with the object, which, in response to being selected by a user, activates/triggers a set function in the corresponding application to be performed.

The operation that is to be performed in response to a user selection of the second-mode representation corresponding to the object. For example, the operation that is to be performed in response to a user selection of the second-mode representation corresponding to the object is an activation/opening of the object.

The ID of the second-mode representation corresponding to the object. The ID of the second-mode representation corresponding to the object may be, for example, the name of the object.

Transmission of the above-described events to create or update setting information to be used to generate objects' second-mode representations in the second-mode view in the process of switching from a first-mode view to a second-mode view keeps the second-mode representations updated and may inform the corresponding objects (e.g., applications) of the second-mode representations' presentation status on the desktop. Received events may serve as a basis for the objects to perform the corresponding operations.

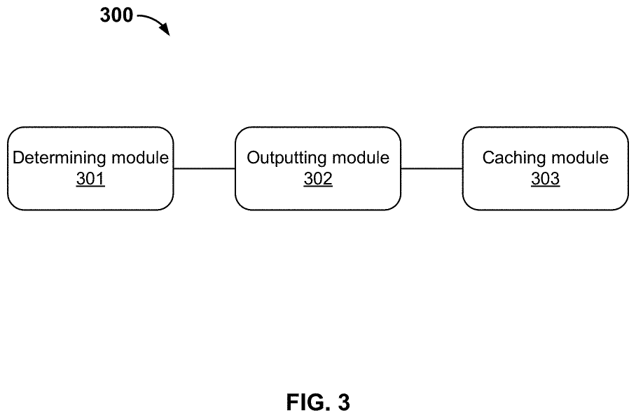

FIG. 3 is a diagram showing an example of a system for switching presentations of representations of objects at a user interface. System 300 is configured to implement a process of switching between a first-mode view of representations of objects and a second-mode view of representations of objects. System 300 includes determining module 301 and outputting module 302. Optionally, system 300, as shown in FIG. 3, may further include caching module 303. In some embodiments, system 300 may be configured to be a part of a device with a display screen (e.g., a touch screen).

The modules and units described herein can be implemented as software components executing on one or more processors, as hardware such as programmable logic devices, and/or Application Specific Integrated Circuits are designed to elements that can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The modules and units may be implemented on a single device or distributed across multiple devices.

After receiving a request to switch from a first-mode view to a second-mode view, determining module 301 is configured to determine, for at least some of the objects corresponding to first-mode representations in the first-mode view that is currently presented at a display screen of a device, corresponding second-mode representations to be presented in a second-mode view. Outputting module 302 is configured to present the second mode view at the display screen of the device. The outputted second-mode view comprises the determined second-mode representations corresponding to at least some of the objects for which first-mode representations were presented in the first-mode view.

In some embodiments, caching module 303 is configured to cache the setting information that was used to generate the second-mode representations in the second-mode view after the second-mode view is outputted by outputting module 302. By caching a previously presented second-mode view, the next time determining module 301 receives a request to switch from the first-mode view to the second-mode view, determining module 301 is configured to obtain the cached setting information for the second-mode representations in the second-mode view and to send a third (update) event to the objects corresponding to those second-mode representations in the second mode view whose setting information had been cached. In response to sending the third (update) event to the object, determining module 301 is configured to receive the updated setting information and use it to generate updated second-mode representations corresponding to the objects that had sent back updated setting information. Outputting module 302 is configured to display the updated second-mode representations in the second-mode view that were determined based on the cached setting information for the second-mode representations in the second-mode view and the received updated setting information for the second-mode representations.

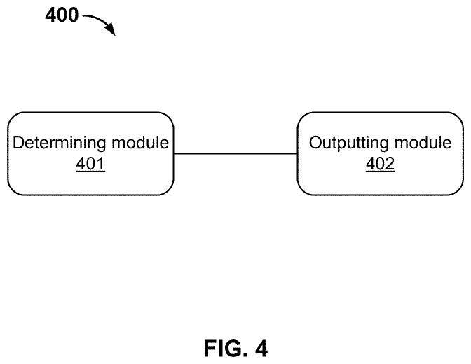

FIG. 4 is a diagram showing a second example of a system for switching presentations of representations of objects at a user interface. System 400 is configured to implement a process of switching between a first-mode view of representations of objects and a second-mode view of representations of objects. System 400 includes determining module 401 and outputting module 402. In some embodiments, system 400 may be configured to be a part of a device with a display screen (e.g., a touch screen).

After receiving a request to switch from a second-mode view to a first-mode view, determining module 401 is configured to determine, for at least some of the objects corresponding to second-mode representations in the second-mode view that is currently presented at a display screen of a device, corresponding first-mode representations to be presented in the first-mode view. Outputting module 402 is configured to output the first mode view. The outputted first-mode view comprises the determined first-mode representations.

The processes that were described above comprising switching from a first-mode view to a second-mode view and switching from a second-mode view to a first-mode view may be implemented on a single view switching system. Specifically, the functions of the determining modules of the view switching module described above may be merged, and the functions of the outputting modules of the view switching module described above may be merged.

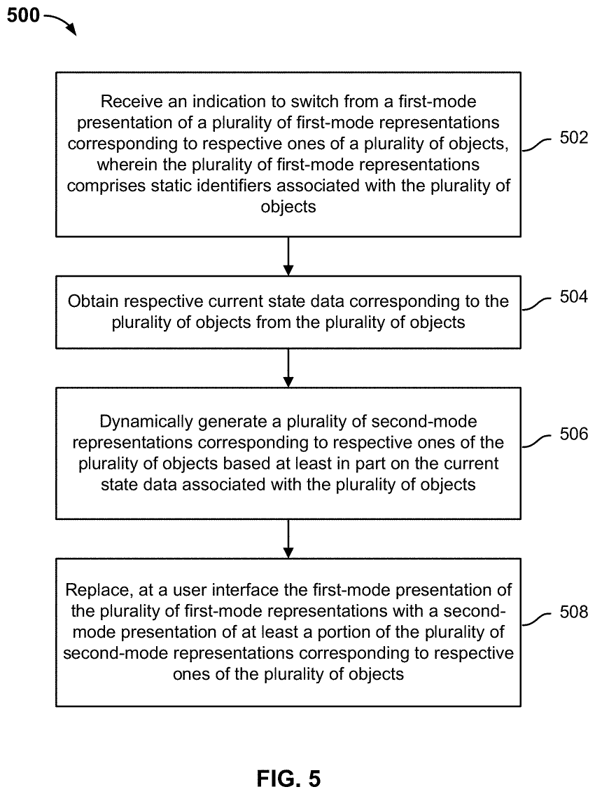

FIG. 5 is a flow diagram showing an embodiment of a process for switching object representation views at a device display screen. In some embodiments, process 500 may be implemented at a system such as system 300 of FIG. 3.

At 502, an indication to switch from a first-mode presentation of a plurality of first-mode representations corresponding to respective ones of a plurality of objects is received, wherein the plurality of first-mode representations comprises static identifiers associated with the plurality of objects. In various embodiments, a first-mode presentation (first-mode view) is presented at a display screen of a device by default (e.g., when the device is turned on). For example, the objects comprise software elements that are executing at the device. Specific examples of objects comprise applications and file folders (e.g., that include a group of icons) and as such, example respective first-mode representations of such objects comprise application icons and a folder icon. The applications and/or folder icons include static information associated with the objects such as the names/identifiers of the objects and/or thumbnail images associated with the objects.

At 504, respective current state data corresponding to the plurality of objects is obtained from the plurality of objects. Setting information including at least current state data is obtained from the plurality of objects. The current state data comprises recent data that the object has obtained with respect to its function. For example, the current state data would normally be presented to the user after an object such as an application is activated/opened but in various embodiments herein, at least a portion of the object's current state data is presented as a preview within the second-mode representation corresponding to the object.

At 506, a plurality of second-mode representations corresponding to respective ones of the plurality of objects is dynamically generated based at least in part on the current state data associated with the plurality of objects. Second-mode representations are dynamically generated based at least in part on the current state data. Because an object's current state data may change or become updated over time, in various embodiments, each time that the object's second-mode representation is requested to be presented, the second-mode representation is dynamically generated based on the object's current state data. For example, at least a portion of the current state data corresponding to an object is used to generate a preview of such data to be presented within the object's second-mode representations. In some embodiments, setting information other than current state data is also used to generate the second-mode representation corresponding to the objects. For example, other setting information that is used to generate the second-mode representation corresponding to the objects includes the arrangement mode, the size, the position within the arrangement, descriptive information associated with the object, and one or more controls associated with the object.

At 508, the first-mode presentation of the plurality of first-mode representations is replaced, at a user interface, with a second-mode presentation of at least a portion of the plurality of second-mode representations corresponding to respective ones of the plurality of objects. In other words, the first-mode presentation is removed from the user interface and the second-mode presentation is displayed at the user interface/display screen of the device. As mentioned above, an object's second-mode representation may include one or more of the following: a piece of media that describes that object, at least a portion of the current state data associated with the object, and a control associated with the object. In some embodiments, the second-mode presentation (second mode view) comprises second-mode representations of the same size or different sizes. By simultaneously presenting second-mode representations of objects such as applications, for example, adjacent to each other at a user interface (display screen) of a device, a user is able to see previews of various current state/content that is being processed by each corresponding object without even needing to open/activate any of the objects.

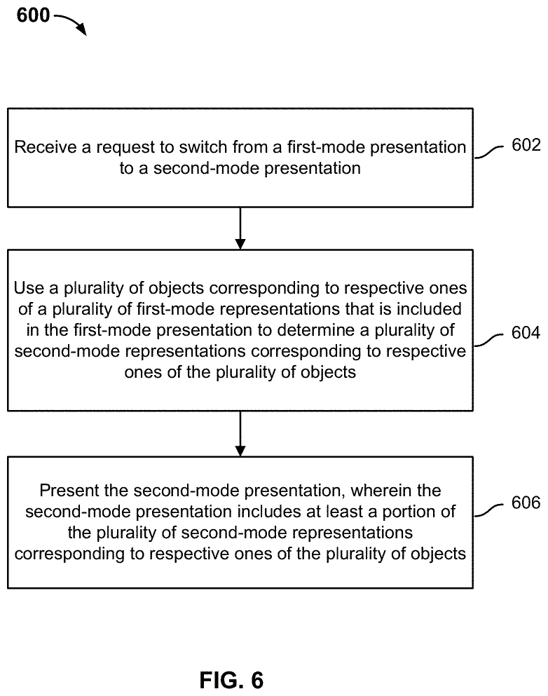

FIG. 6 is a flow diagram showing an embodiment of a process for switching from a first-mode view to a second-mode view at a device display screen. In some embodiments, process 600 may be implemented at a system such as system 300 of FIG. 3.

At 602, a request to switch from a first-mode presentation to a second-mode presentation is received. The request may be generated based on a detected predetermined user interface interactive action. For example, the predetermined set user interface interactive action includes a touchscreen operation such as an (e.g., full-screen) upward swipe. The request may also be generated according to a user interactive action of another type other than a touchscreen operation. For example, the request is generated in response to a detected user interaction with a (e.g., hard or soft) function key on the terminal. The request may be generated by one particular application according to its logic or by several according to their logic. In some embodiments, in response to the detected predetermined user interface interactive action from a first-mode presentation to a second-mode presentation, a preparation event and/or creation event is sent to the objects.

At 604, a plurality of objects corresponding to respective ones of a plurality of first-mode representations that is included in the first-mode presentation is used to determine a plurality of second-mode representations corresponding to respective ones of the plurality of objects. After the request is received, a preparation event is sent (e.g., by an operating system) to the objects corresponding to the first-mode representations in the first-mode view. In response to the received preparation event, the corresponding objects obtain the setting information that is to be used to generate their corresponding second-mode representations. In some embodiments, a creation event is sent (e.g., by an operating system) to the objects to cause the objects to send back the prepared setting information. The second-mode representations corresponding to the objects are then dynamically generated based on the prepared setting information.

At 606, the second-mode presentation is presented, wherein the second-mode presentation includes at least a portion of the plurality of second-mode representations corresponding to respective ones of the plurality of objects. The second-mode view is presented at the desktop of the user interface at the device.

In some embodiments, the setting information corresponding to the objects for which second-mode representations were generated may be cached. As such, the next time a request for switching from the first-mode view to the second-mode view is received, the cached setting information may be obtained from storage. Furthermore, an update event may be issued (e.g., by an operating system) to the objects corresponding to those second-mode representations in the second-mode view whose cached setting information is in need of updating to obtain updated setting information for the second-mode representations corresponding to the objects. For example, a second-mode representation whose setting information needs updating is a second-mode representation whose setting information was cached more than a predetermined length of time ago. A second-mode representation whose setting information does not need updating is a second-mode representation whose setting information was cached less than a predetermined length of time ago. Therefore, the updated setting information is used to generate a second-mode representation whose setting information needed to be updated and the cached second-mode representation setting information is used to generate a second-mode representation whose setting information did not need to be updated. By selectively collecting updated setting information from only objects whose second-mode representation needs updating, information exchanges between the operating system and the objects (e.g., applications) can be reduced to improve processing efficiency. The updated setting information and the cached setting information are used to dynamically generate updated second-mode representations that are to be presented within the second-mode view.

In some embodiments, the setting information for second-mode representations is cached by the corresponding objects. For example, an object caches its own object-specific setting information in a portion of storage that is associated with that particular object. While the first-mode view comprising first-mode representations of objects is presented at a user interface, the objects corresponding to such first-mode representations may receive a preparation event (e.g., from an operating system). In response to the preparation event, the objects prepare their respective setting information and then cache the setting information. Thus, whenever a creation or update event is received at the objects, the objects can send back the prepared setting information for the second-mode representations to the sender of the second or third event.

In some embodiments, with respect to system 300 of FIG. 3, steps 602 and 604 of process 600 may be executed by determining module 301 and step 606 may be executed by outputting module 302.

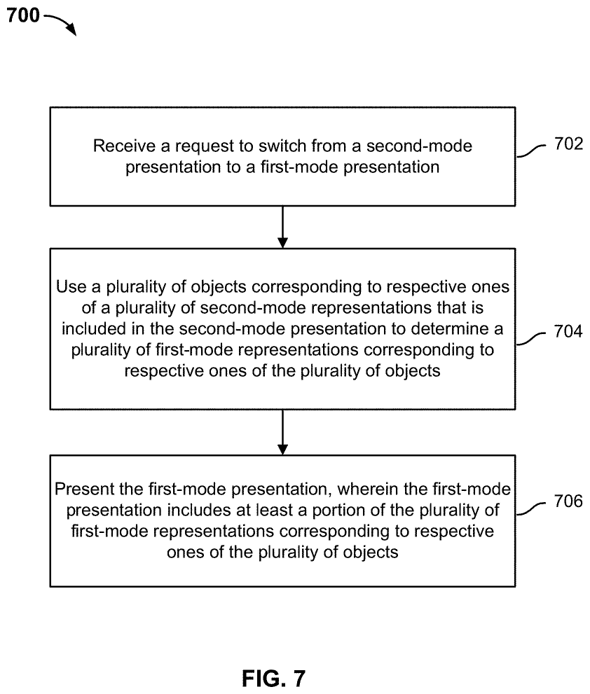

FIG. 7 is a flow diagram showing an embodiment of a process for switching from a second-mode view to a first-mode view at a device display screen. In some embodiments, process 700 may be implemented at a system such as system 400 of FIG. 4.

At 702, a request to switch from a second-mode presentation to a first-mode presentation is received. In some embodiments, after a request for switching from a second-mode view to a first-mode view is received, an exit event is issued (e.g., by an operating system) to the objects corresponding to the second-mode representations in the second-mode view. The exit event is configured to notify the corresponding objects of the need to exit the second-mode view and to display the first-mode view.

At 704, a plurality of objects corresponding to respective ones of a plurality of second-mode representations that is included in the second-mode presentation is used to determine a plurality of first-mode representations corresponding to respective ones of the plurality of objects. For example, the first-mode representations corresponding to objects are obtained from storage (e.g., a saved file). For example, a first-mode representation corresponding to an object may be updated based on an update that is received from a server. In a specific example, an object comprises an application and its first-mode representation comprises an application icon that may be occasionally updated based on an update that is received from a server associated with the application.

At 706, the first-mode presentation is presented, wherein the first-mode presentation includes at least a portion of the plurality of first-mode representations corresponding to respective ones of the plurality of objects.

In some embodiments, with respect to system 400 of FIG. 4, steps 702 and 704 of process 700 may be executed by determining module 401 and step 706 may be executed by outputting module 402.

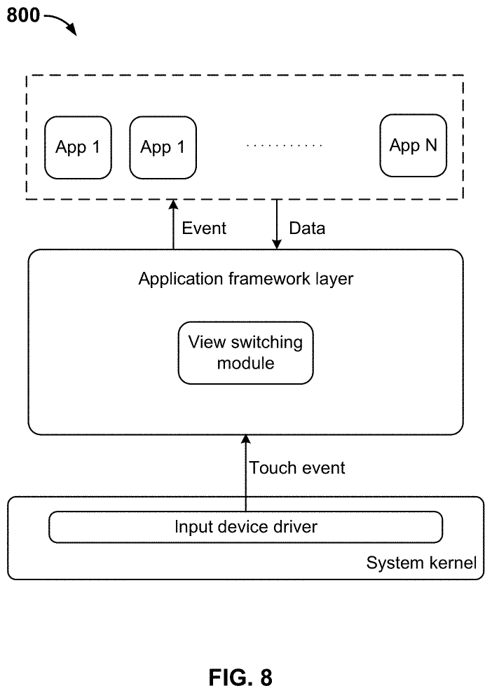

While various embodiments described herein may be applied to various types of devices, for the purpose of illustration, FIG. 8, below, describes a system architecture pertaining to the device of a mobile phone.

FIG. 8 is a diagram showing an embodiment of a system architecture of a mobile phone. In the example of FIG. 8, only components of the mobile phone that are related to the techniques described herein are shown. As shown in the drawing, in system 800, the application framework layer in the system architecture may include a “view switching module.” This module may specifically be manifested as a system service and is configured to implement the functions described herein associated with switching between views in different modes. The application framework layer may further include an input manager service, a windows manager service, and other system service (not shown in FIG. 8). For example, the input manager service is configured to read a touch event from the lower-layer input device driver, process it, and send the touch event to the “view switching module.” If the “view switching module” determines that the touch event is an event triggering a switch from the first-mode view to the second-mode view, then the view switching is processed according to embodiments described herein.

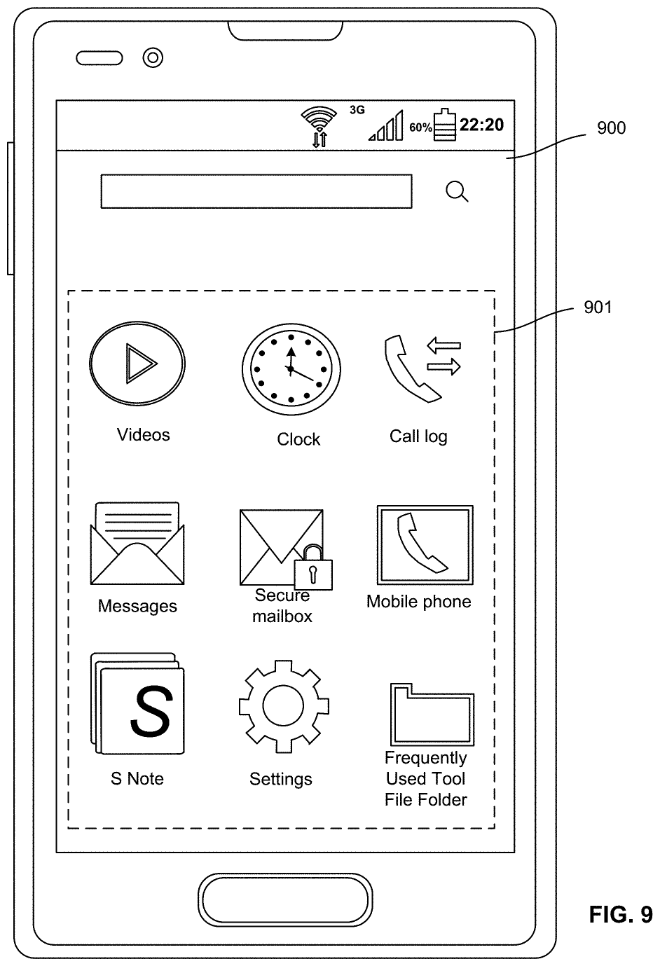

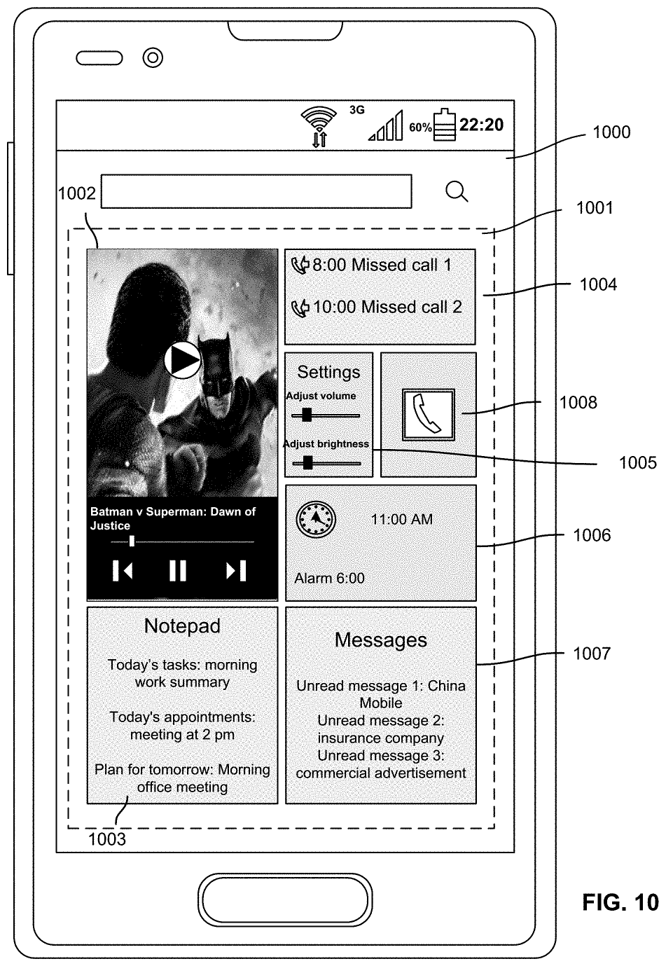

For example, when a mobile phone is powered on and its operating system starts, a first-mode view comprising first-mode representations of objects is presented. FIG. 9 shows an example first-mode view at a display screen of a mobile phone. In the examples of FIGS. 9 and 10, objects include applications and also folders that include sets of applications. While the first-mode view is being presented, the “view switching module” in the application framework layer of FIG. 8 sends a preparation event to the applications corresponding to the application icons described above in the first-mode view to cause these applications to determine the setting information for the corresponding second-mode representations and to cache it. First display region 901 in first-mode view 900 of FIG. 9 includes nine first-mode representations, which are icons, eight of which are application icons. The icon in the lower-right corner labeled as “Frequently Used Tool File Folder” is a file folder icon. The “Frequently Used Tool File Folder” includes icons for some frequently used applications.

After the user performs an upward-swipe operation (which is the predetermined interactive set action to request a switch from the first-mode view to the second-mode view) on the phone touchscreen, the “input device driver” in the system kernel of FIG. 8 acquires the touch event and sends it to the “view switching module” of the application framework layer. The “view switching module” of FIG. 8 determines that the event is configured to trigger a switch from the current first-mode view to the second-mode view. Therefore, the “view switching module” of FIG. 8 sends a creation event to the applications corresponding to the first-mode representations in the first-mode view. In response to the creation event, the applications obtain the cached setting information for the second-mode representations and send it back to the “view switching module” of FIG. 8. The view switching module generates the second-mode view based on the received setting information for the second-mode representations and displays it. In some embodiments, when generating the second-mode view, the “view switching module” may use application type, application use frequency, and other such information as a basis to determine the positions, arrangement, sizes, and so on of the corresponding second-mode representations so that the user may conveniently select the application he or she needs.

FIG. 10 shows an example second-mode view at a display screen of a mobile phone. As shown in FIG. 10, second-mode view 1000 includes second display region 1001. Because it is determined that a video-playing application had a historically high frequency of use by the user of the mobile phone, the video-playing application's corresponding second-mode representation 1002 has been presented in a more conspicuous position (e.g., the first page) within the arrangement of second-mode representations in second display region 1001. Second-mode representation 1002 shows a thumbnail or a frame from a current video (“Batman v Superman: Dawn of Justice”) that has been opened in the video-playing application. Second-mode representation 1002 presents four controls associated with the video playing application. The controls include a play button, a previous video button, a pause button, and a next video button. In some embodiments, in response to a user selection of one of the controls within second-mode representation 1002, the playback of the current video featured within second-mode representation 1002 would be affected within second-mode representation 1002, which will continue to display among the other second-mode representations within second display region 1001. In some embodiments, in response to a user selection of one of the controls within second-mode representation 1002, the corresponding video playing application will be activated/opened at the mobile phone and the playback of the current video will proceed within the activated/opened video playing application. As further shown in second display region 1001, a notepad application had a historically high frequency of use by the user of the mobile phone and as a result, the notepad application's corresponding second-mode representation 1003 is presented in a more conspicuous position (e.g., the first page) within the arrangement of second-mode representations in second display region 1001. At least a portion of the current information that has been input in and/or stored by the notepad application is presented within second-mode representation 1003. Showing at least a portion of the current information associated with the notepad application in its second-mode representation 1003 offers the user a preview of such information without requiring the user to activate/open the notepad application. This enables the user to know the notepad information without having to start the notepad application. Second-mode representation 1004 corresponding to a call log application presents at least some of the missed calls that were recently received at the mobile phone. Second-mode representation 1005 corresponding to a settings application presents the controls for controlling volume and brightness at the mobile phone (e.g., because such controls were determined to be, historically, the most frequently used). Second-mode representation 1006 corresponding to a clock application presents the current time and an upcoming alarm time. Second-mode representation 1007 corresponding to a messaging application presents identifying information associated with at least some unread messages that were recently received at the mobile phone.

After the user selects a second-mode representation in second-mode view 1000, the corresponding application may be activated/opened (e.g., to present over the entire display screen of the mobile phone). For example, a user tapping second-mode representation 1008 corresponding to the phone application may open the telephone number keypad for making phone calls. If the user selects a control in a second-mode representation in the second-mode view, then he or she will cause the corresponding application to complete the corresponding function and/or also activate/open. For example, an operation performed on the control for controlling volume in second-mode representation 1005 corresponding to the settings application will adjust the volume of the mobile phone.

As shown in FIG. 10, by simultaneously presenting second-mode representations of various objects at once at a user interface (display screen) of a device, a user is able to see previews of various current state/content that is being processed by each corresponding object without even needing to open/activate any of the objects.

Embodiments of the present application further provide a communication device 1100 that is based on the same technical concepts. Communication device 1100 may implement the process described in the above embodiments.

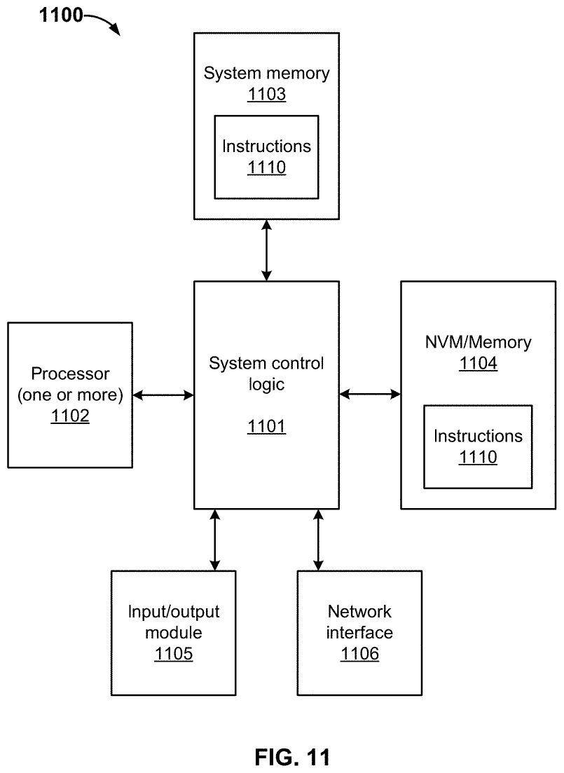

FIG. 11 is a diagram of an embodiment of a communication device that is configured to switch presentations of representations of objects at a user interface. Communication device 1100 comprises one or more processors 1102, system control logic 1101 coupled to one or more processors 1102, non-volatile memory (NVM)/memory 1104 coupled to the system control logic 1101, and network interface 1106 coupled to system control logic 1101.

One or more processors 1102 may comprise one or more single-core processors or multi-core processors. One or more processors 1102 may comprise any combination of general-purpose processors or special-purpose processors (such as image processors, app processors, and baseband processors).

System control logic 1101, in some embodiments, may comprise any appropriate interface controller configured to provide any suitable interface to at least one of the one or more processors 1102 and/or to provide any suitable interface to any suitable device or component communicating with system control logic 1101.

System control logic 1101, in some embodiments, may comprise one or more memory controllers that are configured to provide interfaces to system memory 1103. System memory 1103 is configured to store and load data and/or instructions. For example, corresponding to communication device 1100, system memory 1103, in some embodiments, may comprise any suitable volatile memory.

NVM/memory 1104 may comprise one or more physical, non-temporary, computer-readable media for storing data and/or instructions. For example, NVM/memory 1104 may comprise any suitable non-volatile memory module, such as one or more hard disk devices (HDD), one or more compact disks (CD), and/or one or more digital versatile disks (DVD).

NVM/memory 1104 may comprise storage resources. These storage resources physically are part of a device that is installed on the system or that can be accessed, but they are not necessarily a part of the device. For example, NVM/memory 1104 may be accessed by a network via the network interface 1106.

System memory 1103 and NVM/memory 1104 may each include temporary or permanent copies of instructions 1110. Instructions 1110 may include instructions that, when executed by at least one of one or more processors 1102, cause one or a combination of the instructions in the methods described in FIGS. 5 through 7 to be implemented by communication device 1100. In some embodiments, instructions 1110 or hardware, firmware, and/or software components may additionally/alternately be put within system control logic 1101, network interface 1106, and/or one or more processors 1102.

Network interface 1106 may include a receiver to provide communication device 1100 with a wireless interface for communication with one or more networks and/or any suitable device. Network interface 1106 may include any suitable hardware and/or firmware. Network interface 1106 may include multiple antennae to provide multi-input/multi-output wireless interfaces. In some embodiments, network interface 1106 may comprise a network adapter, a wireless network adapter, a telephone modem, and/or a wireless modem.

In some embodiments, at least one of one or more processors 1102 may be packaged together with the logic of one or more controllers of the system control logic. In some embodiments, at least one of the processors may be packaged together with the logic of one or more controllers of the system control logic to form a system-level package. In some embodiments, at least one of the processors may be integrated together with the logic of one or more controllers of the system control logic in the same chip. In some embodiments, at least one of the processors may be integrated together with the logic of one or more controllers of the system control logic in the same chip to form a system chip.

Communication device 1100 may further comprise input/output module 1105. Input/output module 1105 may comprise a user interface that is for causing interaction between the user and communication device 1100. Communication device 1100 may comprise a peripheral component interface, which is designed to enable peripheral components to interact with the system, and/or it may comprise sensors for determining environmental conditions and/or location information relating to communication device 1100.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
one or more processors configured to:
receive an indication to switch from a first-mode presentation of a plurality of first-mode representations corresponding to respective ones of a plurality of objects, wherein the plurality of first-mode representations comprises static identifiers associated with the plurality of objects;
obtain respective current state data corresponding to the plurality of objects from the plurality of objects;
dynamically generate a plurality of second-mode representations corresponding to respective ones of the plurality of objects based at least in part on the respective current state data associated with the plurality of objects; and
replace, at a user interface, the first-mode presentation of the plurality of first-mode representations with a second-mode presentation of at least a portion of the plurality of second-mode representations corresponding to respective ones of the plurality of objects; and
one or more memories coupled to the one or more processors and configured to provide the one or more processors with instructions.

2. The system of claim 1, wherein the plurality of objects comprises one or more of the following: an application, a component, a file folder, and a file.

3. The system of claim 1, wherein to obtain the respective current state data corresponding to the plurality of objects from the plurality of objects comprises to:
send a preparation event to the plurality of objects, wherein the preparation event is configured to cause the plurality of objects to determine setting information including the respective current state data and cache the setting information; and
send a creation event to the plurality of objects, wherein the creation event is configured to cause the plurality of objects to send back the cached setting information.

4. The system of claim 3, wherein the setting information further comprises one or more of the following: an arrangement mode, descriptive information associated with the objects, and controls to be presented within at least some of the plurality of second-mode representations.

5. The system of claim 1, wherein the one or more processors are further configured to determine a plurality of sizes corresponding to respective ones of the plurality of second-mode representations based at least in part on one or more of the following: object types, historical use frequencies of the plurality of objects, and update times of the plurality of objects.

6. The system of claim 1, wherein the at least portion of the plurality of second-mode representations corresponding to the respective ones of the plurality of objects is presented according to an arrangement that is determined based at least in part on one or more of the following: object types, historical use frequencies of the plurality of objects, and update times of the plurality of objects.

7. The system of claim 1, wherein the plurality of second-mode representations is further dynamically generated based at least in part on one or more of the following: pieces of media describing the plurality of objects and controls that are configured within the plurality of objects.

8. The system of claim 1, wherein the indication comprises a first indication and wherein the one or more processors are configured to:
receive a second indication to switch from the first-mode presentation to the second-mode presentation;
in response to the second indication, send an update event to at least a portion of the plurality of objects, wherein the update event is configured to cause the at least portion of the plurality of objects to send respective updated setting information;
use cached setting information associated with the plurality of objects and the respective updated setting information to generate an updated plurality of second-mode representations corresponding to respective ones of the plurality of objects; and
replace the first-mode presentation with the second-mode representation of at least a portion of the updated plurality of second-mode representations corresponding to respective ones of the plurality of objects.

9. The system of claim 1, wherein the indication comprises a first indication and wherein the one or more processors are configured to:
receive a second indication to switch from the first-mode presentation to the second-mode presentation; and
in response to the second indication, send an exit event to the plurality of objects, wherein the exit event is configured to notify the plurality of objects that the second-mode presentation has exited.

10. The system of claim 1, wherein the one or more processors are further configured to:
receive a user selection with respect to a control presented within a second-mode representation corresponding to an object; and
cause the object to perform an operation corresponding to the control.

11. A method, comprising:
receiving an indication to switch from a first-mode presentation of a plurality of first-mode representations corresponding to respective ones of a plurality of objects, wherein the plurality of first-mode representations comprises static identifiers associated with the plurality of objects;
obtaining respective current state data corresponding to the plurality of objects from the plurality of objects;
dynamically generating a plurality of second-mode representations corresponding to respective ones of the plurality of objects based at least in part on the respective current state data associated with the plurality of objects; and
replacing, at a user interface, the first-mode presentation of the plurality of first-mode representations with a second-mode presentation of at least a portion of the plurality of second-mode representations corresponding to respective ones of the plurality of objects.

12. The method of claim 11, wherein obtaining the respective current state data corresponding to the plurality of objects from the plurality of objects comprises:
sending a preparation event to the plurality of objects, wherein the preparation event is configured to cause the plurality of objects to determine setting information including the respective current state data and cache the setting information; and
sending a creation event to the plurality of objects, wherein the creation event is configured to cause the plurality of objects to send back the cached setting information.

13. The method of claim 12, wherein the setting information further comprises one or more of the following: an arrangement mode, descriptive information associated with the objects, and controls to be presented within at least some of the plurality of second-mode representations.

14. The method of claim 11, further comprising determining a plurality of sizes corresponding to respective ones of the plurality of second-mode representations based at least in part on one or more of the following: object types, historical use frequencies of the plurality of objects, and update times of the plurality of objects.

15. The method of claim 11, wherein the at least portion of the plurality of second-mode representations corresponding to the respective ones of the plurality of objects is presented according to an arrangement that is determined based at least in part on one or more of the following: object types, historical use frequencies of the plurality of objects, and update times of the plurality of objects.

16. The method of claim 11, wherein the plurality of second-mode representations is further dynamically generated based at least in part on one or more of the following: pieces of media describing the plurality of objects and controls that are configured within the plurality of objects.

17. The method of claim 11, wherein the indication comprises a first indication and further comprising:
receiving a second indication to switch from the first-mode presentation to the second-mode presentation;
in response to the second indication, sending an update event to at least a portion of the plurality of objects, wherein the update event is configured to cause the at least portion of the plurality of objects to send respective updated setting information;
using cached setting information associated with the plurality of objects and the respective updated setting information to generate an updated plurality of second-mode representations corresponding to respective ones of the plurality of objects; and
replacing the first-mode presentation with the second-mode representation of at least a portion of the updated plurality of second-mode representations corresponding to respective ones of the plurality of objects.

18. The method of claim 11, wherein the indication comprises a first indication and further comprising:
receiving a second indication to switch from the first-mode presentation to the second-mode presentation; and
in response to the second indication, sending an exit event to the plurality of objects, wherein the exit event is configured to notify the plurality of objects that the second-mode presentation has exited.

19. The method of claim 11, further comprising:
receiving a user selection with respect to a control presented within a second-mode representation corresponding to an object; and
causing the object to perform an operation corresponding to the control.

20. A computer program product, the computer program product being embodied in a non-transitory computer readable storage medium and comprising computer instructions for:
receiving an indication to switch from a first-mode presentation of a plurality of first-mode representations corresponding to respective ones of a plurality of objects, wherein the plurality of first-mode representations comprises static identifiers associated with the plurality of objects;
obtaining respective current state data corresponding to the plurality of objects from the plurality of objects;
dynamically generating a plurality of second-mode representations corresponding to respective ones of the plurality of objects based at least in part on the respective current state data associated with the plurality of objects; and
replacing, at a user interface, the first-mode presentation of the plurality of first-mode representations with a second-mode presentation of at least a portion of the plurality of second-mode representations corresponding to respective ones of the plurality of objects.
